(19) United States
(12) Patent Application Publication
(10) Pub. No.: US 2020/0387030 A1
(43) Pub. Date: Dec. 10, 2020

(54) IMAGE GENERATING DEVICE AND ASSOCIATED HEAD-UP DISPLAY

(71) Applicant: VALEO COMFORT AND DRIVING ASSISTANCE, Créteil (FR)

(72) Inventor: David Barate, Créteil (FR)

(73) Assignee: VALEO COMFORT AND DRIVING ASSISTANCE, Créteil (FR)

(21) Appl. No.: 16/314,006

(22) PCT Filed: Jun. 28, 2017
(86) PCT No.: PCT/EP2017/066073

§ 371 Date: Jun. 17, 2019

(30) Foreign Application Priority Data
Jun. 29, 2016 (FR) 1656141

(51) Int. Cl. G02F 1/13357; G02B 27/01; G02F 1/1333; B60K 35/00

(52) U.S. Cl. CPC G02F 1/133605; G02B 27/0149; G02F 1/133608; G02F 1/133385; B60K 2370/33; G02F 1/133603; G02F 2001/133628; B60K 2370/1529; B60K 2370/23; B60K 35/00

(57) ABSTRACT

The invention relates to an image generating device (20) comprising: —at least one light source (23), —a screen (21) designed to be backlit by said light source, and —a reflector (25) arranged between said light source and screen such that an inner face (25A) of the reflector reflects at least some of the light emitted by the light source. The reflector (25) has a thermal conductivity greater than 1 W·m⁻¹·K⁻¹. The invention also relates to a head-up display comprising an image generating device of this type.

### TECHNICAL FIELD TO WHICH THE INVENTION RELATES

The present invention relates generally to the field of head-up displays for vehicles.

It relates more particularly to an image-generating device for a head-up display comprising at least one light source, a screen adapted to be backlit by said light source, and a reflector, arranged between said light source and said screen, and adapted to at least partly reflect the light emitted by the light source.

### TECHNOLOGICAL BACKGROUND

The principle of head-up displays for vehicles is to project images, useful in particular for driving, directly into the visual field of the driver.

For that, the head-up displays generally comprise an image-generating device adapted to generate images and a device for projecting the generated images adapted to transmit these images to a semi-transparent plate placed in the visual field of the driver.

Most of the image-generating devices used today comprise a light source backlighting a screen adapted to generate the images. This screen absorbs a part of the light which backlights it, which causes the thermal heating thereof.

Now, the temperature of the screen is critical for its correct operation, the latter risking being damaged, even being rendered defective, by an excessively high temperature. The heating of the screen can consequently reduce its life and lead to the replacement thereof.

It is therefore necessary to find solutions aiming to cool the screen, or to avoid the heating thereof.

It is known that the temperature of the screen is greatly linked to the heating created by the light source which backlights it.

A first solution is thus known which consists in placing a temperature probe in the image-generating device, this probe being adapted to monitor the temperature of the screen and automatically regulate, as a function of this temperature, the power generated by the light source.

This first solution presents a major drawback in that the user does not always obtain a display with the desired level of brightness since the light source can be made to operate at reduced power.

Furthermore, because of the probe, this first solution is not optimal in terms of bulk of the image-generating device.

Also known is a second solution consisting in opening, at least partially, the image-generating device in order to dispel the heat generated by the light radiation of the light source.

Nevertheless, this second solution does not guarantee the dust-tightness of the image-generating device. Thus, the optics contained in the image-generating device are exposed to dust and risk being damaged.

Furthermore, this second solution means that leaks of light are possible from the light source to the other elements of the head-up display. Stray rays can thus potentially be generated throughout the head-up display and the final quality of the generated image is affected.

### OBJECT OF THE INVENTION

In order to remedy the abovementioned drawbacks of the state of the art, the present invention proposes an image-generating device designed to cool the screen that it comprises and/or avoid the heating of said screen.

More particularly, according to the invention, an image generating device (for head-up display) is proposed comprising at least one light source, a screen adapted to be backlit by said light source, and a reflector arranged between said light source and said screen in such a way that an inner face of said reflector at least partly reflects the light emitted by the light source, wherein the reflector has a thermal conductivity greater than 1 W·m⁻¹·K⁻¹.

Thus, the reflector is adapted to dispel, by thermal conduction effect, a surplus of heat from the image-generating device, for example to heat dissipation elements such as heat-dissipation fins, as proposed below.

Furthermore, advantageously, the reflector defines a recess designed to receive the screen in such a way that said reflector has a zone of thermal contact with said screen.

Thus, with the reflector being in thermal contact with the screen, it is more particularly adapted to conduct and/or dissipate the heat contained in the screen.

Furthermore, with the reflector defining a recess for receiving the screen, it allows for a space-saving in the image-generating device.

Other nonlimiting and advantageous features of the device according to the invention are as follows:
the reflector extends along a main axis of extension and comprises a reflection portion and a support portion;
the support portion defines said recess designed to receive the screen and comprises a flat and a rim which rises from said flat so as to surround the screen;
said flat at least partly forms the zone of thermal contact with the screen;
said screen is directly in contact with the reflector;
the reflector is closed on one side by said screen, on the other by (a support of) the light source, such that said image-generating device forms a closed enclosure;
an outer face of the reflector is provided with a plurality of heat-dissipation fins;
the heat-dissipation fins and the reflector are of a single piece;
the reflector, and possibly the heat-dissipation fins, are produced in a metal material;
the reflector, and possibly the heat-dissipation fins, are produced in a polymer material, for example a filled polymer material;
the heat-dissipation fins cover at least 15% of said outer face of the reflector;
the heat-dissipation fins cover at least 30% of said outer face of the reflector;
the heat-dissipation fins extend over all the height of the reflection portion of the reflector;
the heat-dissipation fins each extend in a direction that is overall at right angles to the main axis of extension of the reflector, parallel to one another;
the heat-dissipation fins are arranged along a plurality of heat-dissipation columns;
the reflector exhibits a thermal conductivity greater than 10 W·m⁻¹·K⁻¹;
a heat sink is provided, arranged behind the light source;
provision is made to thermally insulate the reflector and a support of the light source.

The invention also proposes a head-up display comprising an image-generating device as described previously and an image-projecting device adapted to transmit to a semi-transparent plate the images generated by the image-generating device.

In the head-up display according to the invention, the image-projecting device comprises a mirror arranged so as to reflect to the semi-transparent plate the images generated by the image-generating device.

### DETAILED DESCRIPTION OF AN EXEMPLARY EMBODIMENT

The following description in light of the attached drawings, given by way of nonlimiting examples, will give a good understanding of what the invention consists of and how it can be produced.

In the attached drawings:

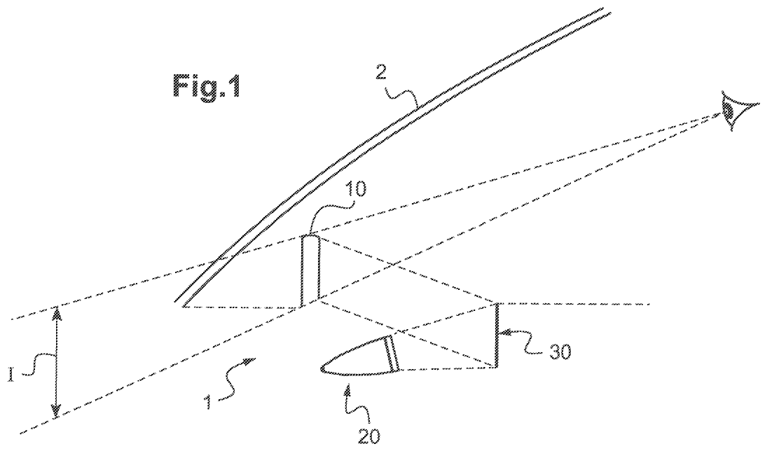

FIG. 1 is a schematic representation of a head-up display according to the invention in position in the vehicle; and

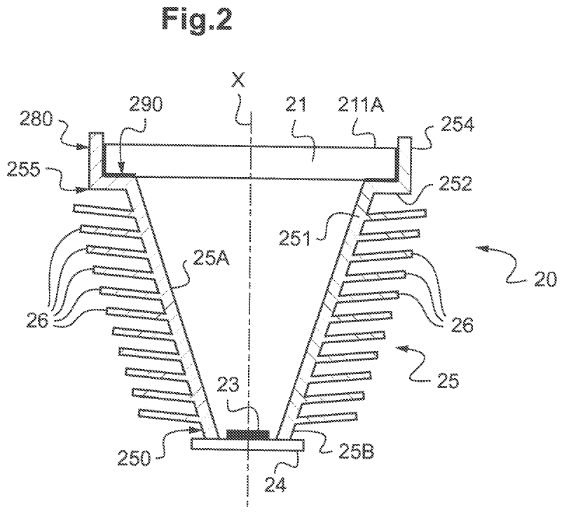

FIG. 2 is a schematic cross-sectional representation of an image-generating device according to the invention.

Hereinafter in the description, the terms “front” and “rear” will be used to denote the elements in position in the motor vehicle, in relation to the longitudinal direction of said motor vehicle. The front will denote the side of an element directed toward the driver, in other words the side turned toward the trunk lid, and the rear will denote the side of this element turned toward the hood.

FIG. 1 shows a representation of the main elements of a head-up display 1 intended to equip a vehicle, for example a motor vehicle.

Such a display 1 is adapted to create a virtual image I in the visual field of a driver of the vehicle, such that the driver can see this virtual image I and any information that it contains without having to divert the gaze from the road.

To this end, the display 1 comprises a semi-transparent plate 10 placed in the visual field of the driver (see FIG. 1), an image-generating device 20 adapted to generate images and an image-projecting device 30 adapted to transmit to said semi-transparent plate 10 the images generated by the image-generating unit 20.

More specifically, the semi-transparent plate 10 is, here, a combiner 10, that is to say a semi-transparent plate dedicated to the head-up display 1.

Here, such a combiner 10 is placed between the windshield 2 of the vehicle and the eyes of the driver.

As a variant, the semi-transparent plate can be merged with the windshield of the vehicle. In other words, in this variant, it is the windshield of the vehicle which serves as semi-transparent plate for the head-up display.

Moreover, here, the image-projecting device 30 comprises a fold back mirror arranged so as to reflect the images generated by the image-generating device 20 toward the semi-transparent plate 10. Here, said fold back mirror is a planar mirror.

As a variant, the image-projecting device can comprise a plurality of mirrors and/or of other optical elements such as a lens for example.

FIG. 2 represents more specifically the image-generating device 20 of the head-up display 1 in cross section.

This image-generating device 20 here comprises at least one light source 23, a screen 21 backlit by said light source 23, and a reflector 25.

In the example represented, the image-generating device 20 in reality comprises a plurality of light sources 23 mounted on a support 24.

The light sources 23 are, here, aligned at right angles to the cutting plane of FIG. 2.

More specifically, each light source 23 is, here, a light-emitting diode (or LED), and all of these LEDs are mounted on a printed circuit board acting as support 24.

It is proposed here to arrange the LEDs in the form of a single row of a plurality of light sources 23, here comprising four light sources 23. As a variant, it is for example possible to consider the plurality of light sources comprising between two and twenty light sources, for example arranged in one or two rows.

The light sources 23 are, here, adapted to backlight the screen 21, said screen 21 being placed at a distance from them. In other words, the screen 21 is lit, on its rear face, by the light sources 23.

In the exemplary embodiment proposed, the screen 21 is a liquid crystal display (LCD) screen, for example with thin film transistors (TFT).

It comprises a matrix of elements of variable transmittance adapted to form the pixels of an image to be displayed when they are backlit by the light sources 23.

Here, the screen 21 comprises a globally planar front face 211A.

The reflector 25 is arranged between the light sources 23 and the screen 21 so as to at least partly reflect the light emitted by the light sources 23 toward the screen 21.

In practice, the reflector 25 extends along a main axis X of extension and comprises a reflection portion 250.

The reflection portion 250 has a globally flared, or frustoconical, form, from the light sources to the screen 21.

To this end, is comprises four walls 251 facing one another in pairs, and which extend slightly obliquely relative to the main axis X of extension, from the light sources 23 to the screen 21.

In the example represented here, the four walls 251 are planar. As a variant, the walls can take any form particularly suited to reflect the maximum of light to the screen.

The four walls 251 are contiguous such that the reflection portion 250 has, at one end, a first aperture where the light sources 23 are housed, and, at the other end, a second aperture (of surface area greater than that of the first aperture) on the side where the screen 21 is placed.

In practice, it is the inner face 25A of the reflector 25 which at least partly reflects the light emitted by the light sources 23.

To this end, the inner face 25A of the reflection portion 250 of the reflector 25 has a high reflection coefficient. It can for example be white so as to generate a diffuse reflection. It has a variant recovered with a reflecting layer (for example of chromium or aluminum) so as to generate a specular reflection.

Thus, both the form and the material of the inner face of the reflector 25 are, here, adapted to reflect all of the light rays emitted by the light sources 23 toward the screen 21.

Furthermore, advantageously, the reflector 25 defines a recess 280 designed to receive the screen 21 such that said reflector 25 has a zone of thermal contact 290 with said screen 21.

The reflector 25 comprises, to this end, a support portion 255 adapted to support and house the screen 21, and to create a thermal contact therewith.

In practice, the screen support portion 255 extends from the second aperture of the reflection portion 250 of the reflector 25.

More specifically, each wall 251 of the reflection portion 250 of the reflector 25 is, here, prolonged by a flat 252 which extends outward from said reflector 25. Here, the flats extend in a plane globally parallel to the support 24 of the light sources 23.

The flats 252 are adapted to accommodate the screen 21, as is represented in FIG. 2.

Each flat 252 is itself prolonged by a rim 254, which extends globally at right angles to said corresponding flat 252, away from the light sources 23.

Thus, each rim 254 is, here, globally parallel to the main axis X of extension of the reflector 25.

The support portion 255 of the reflector 25 is thus formed by the four flats 252 and by the four rims 254 prolonging the four walls 251.

The support portion 255 thus defines the recess 280 for receiving the screen 21.

More specifically, the rims 254 of the support portion 255 surrounds the screen 21 to form a frame around said screen 21 when the latter is in contact with the flats 252 of said reflector 25.

By virtue of the support portion 255 of the reflector 25, the screen 21 is incorporated in the reflector 25, which creates a space-saving for the head-up display 1. The image-generating device can thus more easily be incorporated in a motor vehicle dashboard.

Advantageously, the reflector 25 is closed, on one side by the screen 21, and on the other side by the light sources 23 (namely, in practice, by the support 24 of the light sources 23).

Thus, the image-generating device 20 forms a closed enclosure.

Advantageously, the internal elements of the image-generating device are then protected from dust or other external stresses.

The closed enclosure also ensures that no stray ray will be emitted from the light sources 23 directly toward the other elements of the head-up display 1. In other words, the fold back mirror 30 and/or the semi-transparent plate 10 will receive from the image-generating device 20 only the rays that have passed through the screen 21.

The zone of thermal contact 290 between the screen 21 and the reflector 25 is situated on a periphery of at least one of the faces of said screen 21.

Here, the zone of thermal contact 290 is situated over all the periphery of the rear face of the screen 21. Advantageously, that makes it possible to more easily transmit to the reflector 25 the heat accumulated in said screen 21, this heat being first of all accumulated on the rear face of the screen 21 since it originates from the light flux backlighting the screen 21.

In practice, the zone of thermal contact 290 is, here, situated on the flats 252 of the reflector 25, the latter being in thermal contact with the rear face of the screen 21.

Here, the screen 21 is directly in contact with the support portion 255 of the reflector 25.

In other words, provision is made here for the thermal contact to be a physical contact between the screen 21 and the reflector 25. To this end, the screen 21 and the flats 252 of the support portion 255 of the reflector 25 are designed to be perfectly contiguous, that is to say to be in physical contact, with no intermediate layer of air.

As a variant, provision can be made for the screen and the reflector to be in thermal contact via a thermal bridge.

Furthermore, notably, an outer face 25B of said reflector 25 is provided with a plurality of heat-dissipation fins 26.

Thus, advantageously, the reflector 25 serves as heat dissipater (or sink) for the screen 21 in as much as it is adapted to dispel the heat which is accumulated in the screen 21 (this heat being due to the absorption, by the screen, of a part of the light backlighting bit).

The heat-dissipation fins 26 are implanted on the outer face 25B of the reflector 25 so as to cover at least 15% of this outer face 25B.

In other words, if the heat-dissipation fins 26 were all grouped together contiguously, in a single region of the outer face 25B of the reflector 25, this region would represent at least 15% of the total outer face 25B of the reflector 25.

Preferably, the heat-dissipation fins 26 are implanted on the outer face 25B of the reflector 25 so as to cover at least 30% of this outer face 25B.

More specifically, the heat-dissipation fins 26 are, here, grouped together in at least two parcels of fins on the outer face 25B of the reflector 25. In each parcel of fins, the heat-dissipation fins 26 are separated from one another by a thin layer of air. Here, the distance separating two consecutive parcels is greater than the distance separating two consecutive fins 26 of one and the same parcel.

In practice, the heat-dissipation fins 26 here extend over all the height of the reflector 25. They are distributed over all the four walls 251 of the reflection portion 250 of the reflector 25.

According to the embodiment presented in FIG. 2, each parcel of fins 26 takes the form of a column of fins 26. The reflector 25 here comprises four columns of fins. These columns are distributed face-to-face on each wall 251 of the reflector 25. As a variant, it is possible to envisage the fins forming columns distributed in a staggered fashion on the outer face of the reflector.

As a variant, it is possible to envisage the fins being distributed individually randomly on the outer face of the reflector. In this variant, the expression “parcels of fins” no longer applies.

Here, the heat-dissipation fins 26 each extend in a direction globally at right angles to the main axis X of extension of the reflector 25, parallel to one another.

The surface of each fin 26 is optimized to minimize the bulk of the reflector while maximizing the contact with the air surrounding the reflector 25.

Advantageously, by virtue of the fins 26, the surface of contact of the air with the reflector 25 is enlarged.

Thus, by a heat-conduction effect, the heat contained in the screen 21 can be dispelled into the air via the reflector 25. To do this, the reflector 25 is adapted to drain the heat contained in the screen 21 and to distribute this heat over all its surface, that is to say in the four walls 251 and in the plurality of fins 26 that it comprises. Since the heat-dissipation fins 26 are I contact with the air, the heat can then be dispelled into the air, by conduction and/or radiation, then possibly by convection.

In practice, the fins 26 and the reflector 25 are of a single piece. More specifically, here, the fins 26 and the reflector 25 are in a single part.

For the reflector 25 to be able to support the screen 21 while ensuring an effective heat conduction, the reflector 25 (here provided with its heat-dissipation fins 26) is produced in a material that is both rigid and a good conductor of heat (material with a thermal conductivity greater than 1 W·m⁻¹·K⁻¹ and preferably greater than 10 W·m⁻¹·K⁻¹), that it to say adapted to drain the heat from the screen 21 to the walls 251 of the reflector 25.

Thus, here, the reflector 25 (provided in the example described with its heat-dissipation fins 26) is produced in a metal material such as a metal alloy, for example aluminum (having a thermal conductivity greater than 200 W·m⁻¹·K⁻¹, generally of the order of 230 W·m⁻¹·K⁻¹) or Zamak (also called Zamac).

As a variant, the reflector (possibly provided with its heat-dissipation fins) can be produced in a rigid polymer material (preferably having a thermal conductivity greater than 10 W·m⁻¹·K⁻¹), for example a filled polymer material such as Makrolon TC8030 (thermoconductive polycarbonate).

Filled polymer should be understood to mean a composite material based on polymer (for example polycarbonate) also comprising an additional material making it possible to obtain a good thermal conductivity (typically a thermal conductivity greater than 1 W·m⁻¹·K⁻¹, even than 10 W·m⁻¹·K⁻¹).

Thus, the reflector 25, possibly provided with the heat-dissipation fins 26, makes it possible to effectively cool the screen 21 and/or avoid the heating of said screen 21. The driver of the vehicle can then obtain the level of brightness that he or she desires for the virtual image seen by virtue of the semi-transparent plate 10.

In practice, the reflector 25, provided with its support portion 255 and its heat-dissipation fins 26, is manufactured by molding.

More specifically, each wall 251 is molded with, on its outer face, the heat-dissipation fins 26 distributed in at least one column, and, at its wider end, the flat 252 prolonged by the rim 254.

Each wall 251 then forms a single part with the corresponding fins 26, flat 252 and rim 254.

The walls 251 are then assembled together contiguously to form the reflector 25. Such an assembly is produced by bonding or by welding depending on the material used to mold the walls.

The inner face 25A of the reflector 25 can then be painted or covered with a reflecting layer.

As a variant, it is possible to envisage each wall being molded without the fins, only with the flat prolonged by the rim. The walls would then be assembled together, and the fins bonded, using a glue suitable for transmitting the heat, or welded, to the outer face of the reflector.

In another variant, the reflector provided with its walls, its heat-dissipation fins and its support portion, is produced as a single part, using a suitable mold into which said material that is rigid and a good heat conductor is injected.

The reflector 25 thus obtained is therefore suitable for fulfilling several functions, namely, its first reflector function, that of screen support and also that of heat sink.

As a variant, provision can be made to add to the image-generating device a heat dissipation sink placed behind the support of the light sources, so as to partly dissipate the heat generated by said light sources. Such a heat-dissipation sink is for example a fan. It is also possible, particularly when a direct chip mounting (or “On Chip Board”), technique is used, to use, as support, the heat dissipater usually associated with the light sources.

Advantageously, in this variant, the reflector and the support are in thermal contact, such that the heat-dissipation sink of the light sources is also adapted to dissipate the heat from the reflector, in addition to the fins. The combined effect of the reflector and of the heat-dissipation sink makes it possible to further enhance the cooling of the screen.

In another variant, provision can be made to thermally insulate the support of the light sources and the reflector, such that the support cannot transmit heat to the reflector, and vice versa.

According to another variant, it is possible to consider each rim of the support portion of the reflector being prolonged by a second flat, extending parallel to the first flat already provided. Thus, the screen would be sandwiched between the two flats and the rim, and the zone of thermal contact between the screen and the reflector would be enlarged.

1. An image-generating device comprising:
at least one light source;
a screen backlit by said light source; and
a reflector arranged between said light source and said screen such that an inner face of said reflector at least partly reflects the light emitted by the light source,
wherein the reflector has a thermal conductivity greater than 1 W·m⁻¹·K⁻¹.

2. The image-generating device as claimed in claim 1, wherein the reflector also defines a recess that receives the screen such that said reflector has a zone of thermal contact with said screen.

3. The image-generating device as claimed in claim 2, wherein the reflector extends along a main axis of extension and comprises a reflection portion and a support portion,
said support portion defining said recess that receives the screen and comprising:
a flat portion at least partly forming the zone of thermal contact with the screen, and
a rim which rises from said flat portion so as to surround the screen.

4. The image-generating device as claimed in claim 1, wherein said screen is directly in contact with the reflector.

5. The image-generating device as claimed in claim 1, wherein the reflector is closed on one side by said screen, on the other by a support of the light source, such that said image-generating device forms a closed enclosure.

6. The image-generating device as claimed in claim 1, wherein an outer face of said reflector is provided with a plurality of heat-dissipation fins.

7. The image-generating device as claimed in claim 6, wherein the heat-dissipation fins and the reflector are of a single piece.

8. The image-generating device as claimed in claim 6, wherein the heat-dissipation fins cover at least 15% of said outer face of the reflector.

9. The image-generating device as claimed in claim 1, wherein the reflector is produced in a metal material.

10. The image-generating device as claimed in claim 1, wherein the reflector is produced in a filled polymer material.

11. A head-up display comprising:
an image-generating device as claimed in claim 1; and
an image-projecting device for transmitting to a semi-transparent plate the images generated by the image-generating device.

12. The head-up display as claimed in claim 11, wherein the image-projecting device comprises a mirror arranged to reflect to the semi-transparent plate the images generated by the image-generating device.
